(19) United States
(12) Patent Application Publication
(10) Pub. No.: US 2008/0215788 A1
(43) Pub. Date: Sep. 4, 2008

(54) CONNECTOR WITH OPPOSITE-FACING PORTS

(75) Inventor: Noam Kedem, Foster City, CA (US)

Correspondence Address: MARK M. FRIEDMAN, C/O DISCOVEY DISPATCH , 9003 FLIRIN WAY, UPPER MARLBORO, MD, 20772, US

(73) Assignee: SanDisk IL Ltd., Kfar Saba, IL (US)

(21) Appl. No.: 12/099,191

(22) Filed: Apr. 8, 2008

Related U.S. Application Data
(63) Continuation of application No. 10/634,871, filed on Aug. 6, 2003.

(51) Int. Cl. G06F 13/00

(52) U.S. Cl. 710/300

(57) ABSTRACT

A connector for connecting a host device to one or more peripheral devices includes two ports, for example two USB ports, facing in two different, preferably opposite, directions. The scope of the invention also includes a system board that includes the connector, and a host device, such as a computer, that includes the motherboard.

### FIELD AND BACKGROUND OF THE INVENTION

The present invention relates to connectors for connecting peripheral devices to host devices such as computers and, more particularly, to a dual USB connector with opposite-facing ports.

FIGS. 1A and 1B are, respectively, top and partial back views of an ASUS P4P800 Deluxe™ motherboard 50, made by ASUSTeK Computer Inc. of Taipei, Taiwan. Specifically, FIG. 1B shows the back plane of motherboard 50. As described in ASUS P4P800 Deluxe—User Guide, E1323, Revised Edition V3 (ASUSTeK Computer Inc., May 2003), motherboard 50 includes the following components:

ATX 12V connector 1

CPU socket 2

North Bridge controller 3

Double Data Rate (DDR) Dual In-line Memory Module (DIMM) sockets 4

ATX power connector 5

Super I/O controller 6

Floppy disk connector 7

Integrated Drive Electronics (IDE) connectors 8

Accelerated Graphics Port (AGP) slot 9

Serial Advanced Technology Attachment (ATA) connectors 10

Speech controller 11

Redundant Arrays of Independent Disks (RAID) Ultra ATA/133 connector 12

Flash ROM 13

South Bridge controller 14

ATA133 RAID controller 15

Standby Power LED 16

WiFi slot 17

1394 controller 18

Peripheral Component Interconnect (PCI) slots 19

Audio coder/decoder (CODEC) 20

Gigabit LAN controller 21

PS/2 mouse port 22

Parallel port 23

Institute of Electrical and Electronic Engineers (IEEE) 1394 port 24

Registered Jack (RJ)-45 Ethernet port 25

Line-In jack 26

Line-Out jack 27

Microphone jack 28

Four Universal Serial Bus (USB) 2.0 ports 29 and 30

Serial port 31

Sony/Philips Digital Interface (S/PDIF) output port 32

Keyboard port 33

USB ports 29 and RJ-45 port 25 are housed in a common connector 52.

Similarly, USB ports 30 and IEEE 1394 port 24 are housed in a common connector 54. All four USB ports 29 and 30 face outward, and are suitable for connecting, to a host device such as a computer that is based on motherboard 50, an external USB peripheral device with a suitable form factor, such as the DiskOnKey™ flash memory device made by M-Systems Flash Disk Pioneers, Ltd. of Kfar Saba, Israel.

Other connectors in motherboard 50 include a connector 60 that houses PS/2 mouse port 22 and keyboard port 33, a connector 62 that houses parallel port 23, and a connector 64 that houses Line-In jack 26, Line-Out jack 27 and microphone jack 28.

FIG. 2 is a line drawing of connector 52 detached from motherboard 50, showing USB ports 29 and RJ-45 port 25 in a common housing 58. Pins 56 at the base of housing 58 are for connecting connector 52 electrically and mechanically to motherboard 50.

Because USB ports 29 of connector 52 and USB ports 30 of connector 54 face outward when connectors 52 and 54 are mounted on motherboard 50, only external USB peripheral devices can be connected to motherboard 50, or to a host device such as a computer that is based on motherboard 50, at ports 29 and 30. In particular, a system designer is prevented from incorporating a USB flash memory, such as a DiskOnKey™, as an internal component of motherboard 50.

### SUMMARY OF THE INVENTION

The present invention is a connector whose ports face in different directions. In particular, if two ports of the connector face in opposite directions, a system designer is free to use one of the ports, when the connector is mounted on a motherboard, to connect to the motherboard, as an internal peripheral device of a host system based on the motherboard, a device that has the same form factor as a similar device that would connect to the other port as an external peripheral device. Note that in the present context a “port” is understood to be an arrangement, typically but not necessarily a recess, in the connector, that facilitates a mechanical and electrical connection of the connector to a peripheral device. So, for example, pins 56 at the base of housing 58 of connector 52 are specifically not a port as herein understood because pins 56 connect to motherboard 50 and not to a peripheral device, Therefore, according to the present invention there is provided a connector for connecting a host device to at least one peripheral device, including: (a) a first port, facing in a first direction; and (b) a second port, facing in a second direction substantially different from the first direction.

Preferably, the two ports face in opposite directions.

Preferably, the two ports are substantially functionally identical, meaning that both ports provide substantially the same kind of mechanical and electrical connection to the connector. An important special case of this is that in which both ports are USB ports.

The scope of the present invention also includes a system board that incorporates the connector of the present invention and a host device that incorporates the system board of the present invention. Most commonly, the host device is a computer; but the host device could alternatively be a network router, a TV set top box or a mobile device. Note that the system board of a computer generally is called a “motherboard”, so that in the context of the host device being a computer, the terms “system board” and “motherboard” are synonymous. Preferably, in the system board and in the host device, one of the ports faces inward and the other port faces outward. Most preferably, the system board or the host device also includes an internal peripheral device operationally connected to the inward-facing port.

### BRIEF DESCRIPTION OF THE DRAWINGS

The invention is herein described, by way of example only, with reference to the accompanying drawings, wherein:

FIGS. 1A and 1B are top and partial rear views of a prior art motherboard;

FIG. 2 is a line drawing of a prior art connector of the motherboard of FIG. 1B;

FIGS. 3A and 3B are line drawings of a connector of the present invention;

FIG. 4 shows a back plane of a motherboard that includes the connector of FIGS. 3A and 3B;

FIG. 5 is a top view of the motherboard of FIG. 1A, modified according to the present invention, and with a DiskOnKey™ flash memory connected to the inward-facing USB port.

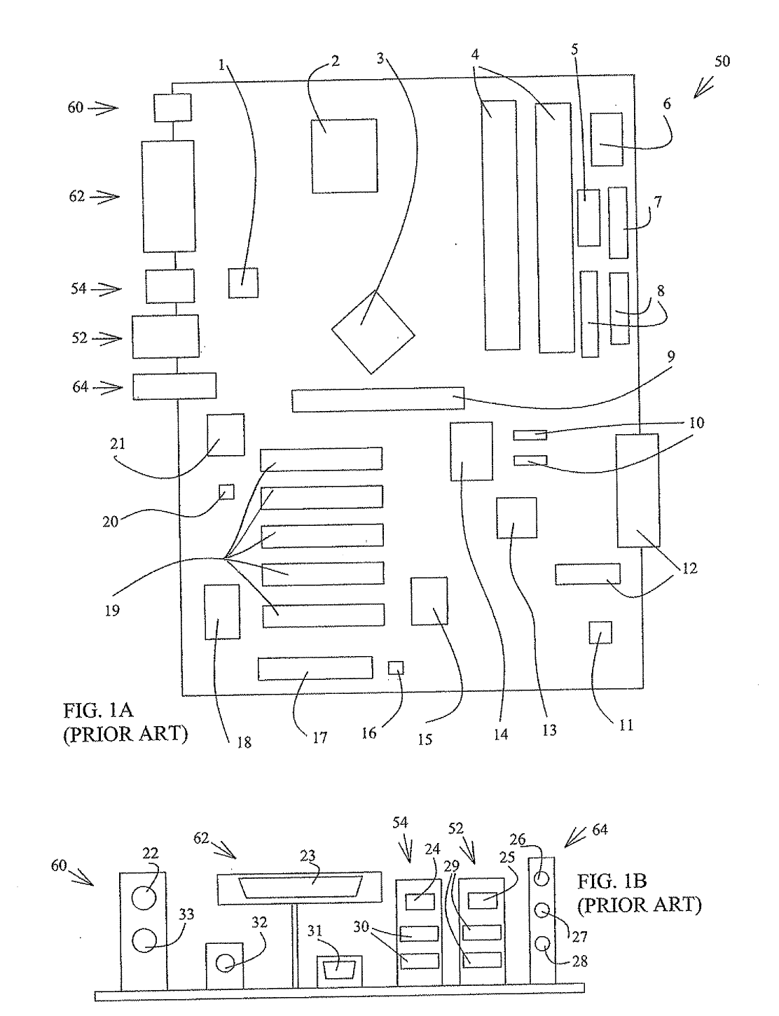

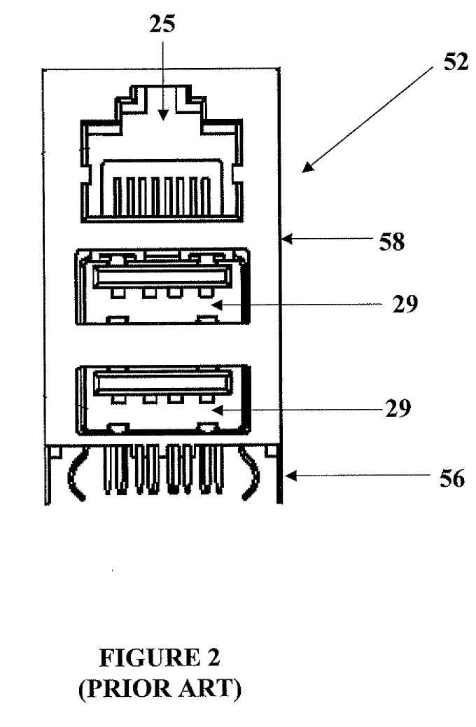

### DESCRIPTION OF THIS PREFERRED EMBODIMENTS

The present invention is of a connector with ports that face in different directions. Specifically, the present invention can be used to connect one peripheral device to a host device on the inside of the host device while leaving open the option of connecting a second, similar peripheral device to the host device on the outside of the host device.

The principles and operation of a connector according to the present invention may be better understood with reference to the drawings and the accompanying description.

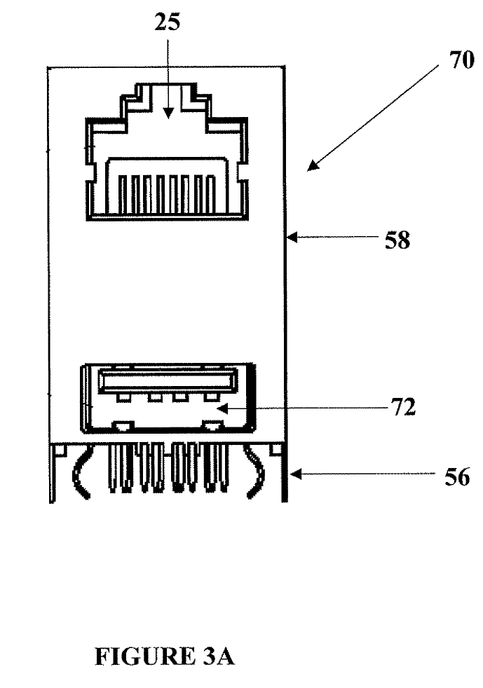

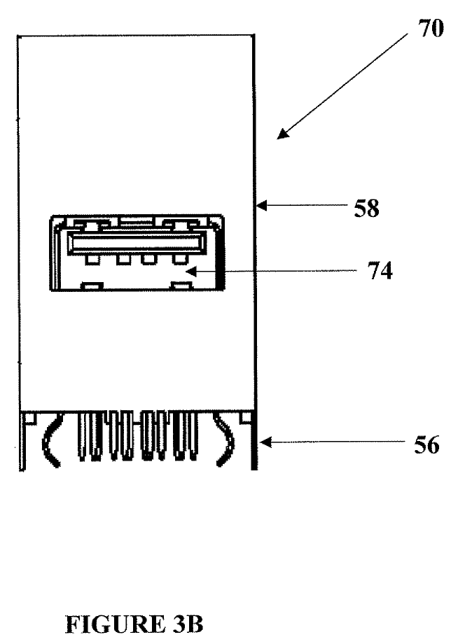

Referring again to the drawings, FIGS. 3A and 3B are line drawings, from opposite sides, of a connector 70 of the present invention. Connector 70 is similar to connector 52, sharing with connector 52 RS-45 port 25 and pins 56 in housing 58. Instead of two USB ports 29 that face in the same direction as RJ-45 port 25, connector 70 has one USB port 72 that faces in the same direction as RJ-45 port 25 and another USB port 74 that faces in the opposite direction to RJ-45 port 25.

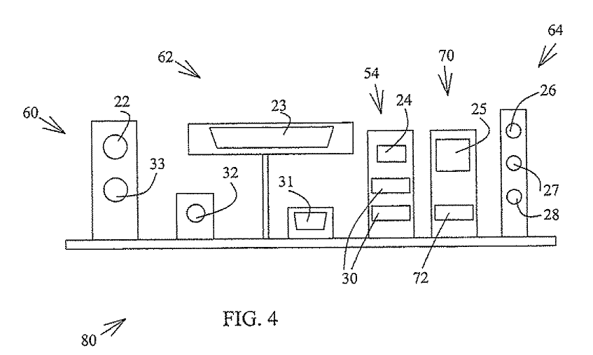

FIG. 4 shows the back plane of a motherboard 80 that is identical to motherboard 50 except for having connector 70 substituted for connector 52. When connector 70 is mounted on motherboard 80 as shown, USB port 72 faces outward along with RJ-45 port 25 and USB port 74 faces inward.

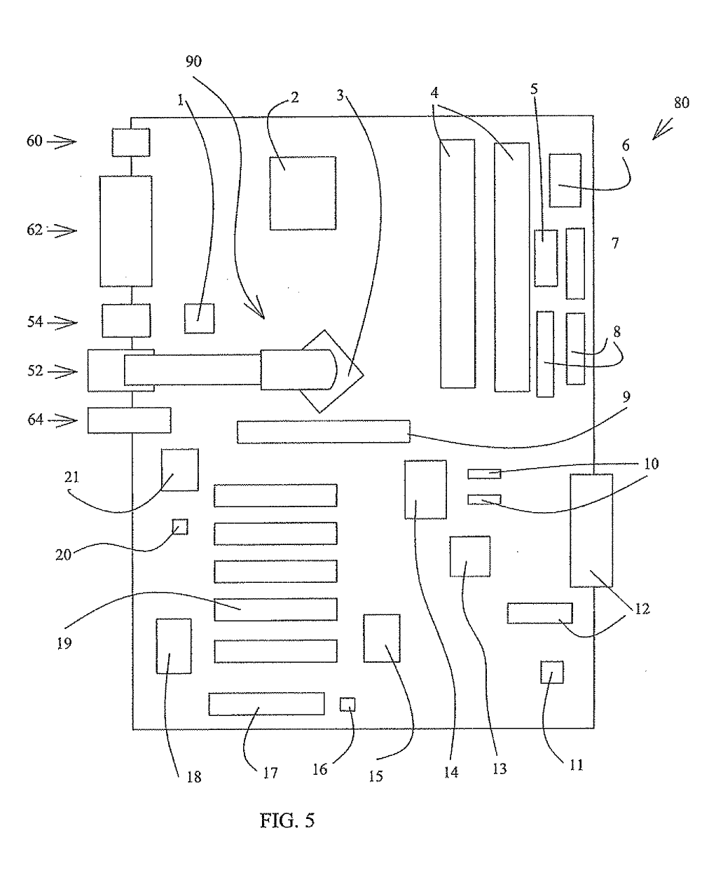

A system designer of a host device based on motherboard 80 is free to include in his or her design an internal USB peripheral device connected to USB port 74 while leaving USB port 72 free for a user of the host device to connect therewith an external USB peripheral device to the host device. For example, a DiskOnKey™ flash memory could be connected to USB port 74 to serve as one of the non-volatile memories of the host device. FIG. 5 shows motherboard 80 with a DiskOnKey™ flash memory 90 connected to USB port 74.

Although it is preferred that USB ports 72 and 74 face in opposite directions as shown, this relative orientation of USB ports 72 and 74 is not an obligatory feature of the present invention. For example, in another embodiment of the connector of the present invention, USB ports 72 and 74 are on two adjacent sides of connector 70 and so are oriented at a 90 degree angle relative to each other. This embodiment could, for example, be mounted on a motherboard in the corner position occupied by connector 60 in motherboards 50 and 80, to allow two external USB peripheral devices to be mounted on two different sides of a host device that is based on that motherboard.

While the invention has been described with respect to a limited number of embodiments, it will be appreciated that many variations, modifications and other applications of the invention may be made.

What is claimed is:

1. A system board comprising:
(a) a connector that includes:
(i) an exterior port situated at an exterior edge at an outermost boundary of the system board and facing outward from the exterior edge; and
(ii) an interior port, facing inward to an interior of the system board in order to accommodate a peripheral device that is electrically connected to the system board only via the interior port.

2. The system board of claim 1, further comprising:
(b) the peripheral device, electrically connected to the system board via the interior port.

3. The system board of claim 1, wherein the ports are substantially functionally identical.

4. A host device comprising the system board of claim 1.

5. The host device of claim 4, wherein the host device is a computer.

6. The host device of claim 4, wherein the host device is a network router.

7. The host device of claim 4, wherein the host device is a TV set top box.

8. The host device of claim 4, wherein the host device is a mobile device.
